(19) United States
(12) Patent Application Publication
(10) Pub. No.: US 2022/0127026 A1
(43) Pub. Date: Apr. 28, 2022

(54) FOOD PRODUCT AMENDMENT APPARATUS AND METHOD OF USE THEREOF

(71) Applicants: Kevin H. Hazen, Flagstaff, AZ (US); Mason Cave, Glendale, AZ (US); Alton J. Reich, Huntsville, AL (US); Sara Geneva Noreau Kerr, St. Paul, MN (US); Michael Roth, Scottsdale, AZ (US); Gavin Hazen, Gilbert, AZ (US)

(72) Inventors: Kevin H. Hazen, Flagstaff, AZ (US); Mason Cave, Glendale, AZ (US); Alton J. Reich, Huntsville, AL (US); Sara Geneva Noreau Kerr, St. Paul, MN (US); Michael Roth, Scottsdale, AZ (US); Gavin Hazen, Gilbert, AZ (US)

(21) Appl. No.: 17/111,366

(22) Filed: Dec. 3, 2020

Related U.S. Application Data
(60) Provisional application No. 63/105,261, filed on Oct. 24, 2020.

(51) Int. Cl. B65B 3/10; A23L 33/105; A23D 7/005; B65B 31/00; G06Q 50/26; G06Q 10/08

(52) U.S. Cl. CPC B65B 3/10; A23L 33/105; A23D 7/0053; G06Q 50/04; G06Q 50/26; G06Q 10/0832; A23V 2002/00; B65B 31/00

(57) ABSTRACT

The invention comprises an apparatus and a method for amending an incomplete product and/or a product to form an amended product, such as by receiving the original product in a first pressurized container, breaking a pressure seal of the first pressurized container, adding tetrahydrocannabinol (THC) to the first pressurized container, and resealing the first pressurized container, such as where optionally a portion of the amendment process is at a second physical location separated from a first location by a state line and/or a legislative boundary.

### CROSS-REFERENCES TO RELATED APPLICATIONS

This application claims the benefit of U.S. provisional patent application no. 63/105,261 filed Oct. 24, 2020, all of which is incorporated herein in its entirety by this reference thereto.

### BACKGROUND OF THE INVENTION

### Field of the Invention

The present invention relates generally to re-packaging food/beverage components.

### Discussion of the Related Art

Food products, such as pressurized food products are typically packed, pressurized, shipped, and used without modification after initial manufacturing.

### Statement of the Problem

No system exists for amending a ready for sale pre-packaged food product after packaging the original food product for sale.

### SUMMARY OF THE INVENTION

The invention comprises a method and apparatus for amending an original food product after packaging of the original food product in ready for sale packaging.

### DESCRIPTION OF THE FIGURES

A more complete understanding of the present invention is derived by referring to the detailed description and claims when considered in connection with the Figures, wherein like reference numbers refer to similar items throughout the Figures.

FIG. 1 illustrates a two-location product preparation system;

FIG. 2 illustrates a two-stage product preparation system;

FIG. 3 illustrates a multiple component formulation;

FIG. 4A illustrates a packaged formulation and FIG. 4B illustrates an amended formulation; and

FIG. 5 illustrates in two-dimensions a molecular structure of tetrahydrocannabinol.

### DETAILED DESCRIPTION OF THE INVENTION

The invention comprises an apparatus and a method for amending an incomplete product and/or a product to form an amended product, where optionally a portion of the amendment process is at a second physical location separated from a first location by a state line and/or a legislative boundary. For example, the invention comprises an apparatus and a method for amending an incomplete product and/or a product to form an amended product, such as by receiving the original product in a first pressurized container, breaking a pressure seal of the first pressurized container, adding tetrahydrocannabinol (THC) to the first pressurized container, and resealing the first pressurized container, such as where optionally a portion of the amendment process is at a second physical location separated from a first location by a state line and/or a legislative boundary.

Herein, a food product refers to a solid food, a drink, and/or a beverage. Optionally, the food product refers to a first component of a subsequent food product, where the first component of the food product is packaged and labeled for sale, such as a syrup of a beverage.

Herein, for clarity of presentation and without loss of generality, tetrahydrocannabinol (THC) is used to illustrate a component that is legal in a second location, such as a licensed THC facility, that is not legal in a first location, such as a manufacturing facility. More generally, many regulated components, formulations, and/or chemicals are legally packaged in a second location where the many regulated components, formulations, and/or chemical may not be legally packed at the first location or shipped from the first location to the second location.

Herein, for clarity of presentation and without loss of generality, a processed cheese sauce is illustrative of a manufactured formulation prepared at a first location, such as a main manufacturing facility that is amended, such as with the addition of tetrahydrocannabinol, at a second facility. Other products that are optionally manufactured at one facility and amended at a second facility include, but are not limited to: whipped cream, icing, cookie dough, and pancakes, where any of the products are optionally delivered from a pressurized canister. More generally, any food product prepared and packaged for sale at a first location is optionally amended, to form an amended food product, at a second location.

Herein, an original food product is optionally packaged for sale in a pressurized container, such as a sprayable cheese product. For clarity of presentation and without loss of generality, examples are provided that amend the originally packaged sprayable cheese product to form an amended sprayable cheese product, such as containing THC. However, generally any originally packaged food/drink product is optionally amended, such as described herein, to form an amended food/drink product, such as an amended gummy, chip, pretzel, snack, candy, baked good, bagged food product, boxed food product, beverage, canned drink, and/or bottled drink.

Herein, for clarity of presentation and without loss of generality, a pressurized device includes, but is not limited to, a pressurized canister, an aerosol canister, a bag-in-can type canister, and/or a piston barrier system, which includes a canister with a product on a dispensing side of the piston and a pressurized gas on the opposite side of the piston. Typically, in an aerosol canister, the propellant is at least partially delivered with the product. Typically, dispensing product from the piston barrier system results in little to no co-dispensing of the pressurized gas until after the product is substantially dispensed, such as greater than 95% of the product has been dispensed.

Multiple Location Product Manufacturing

Generally, a pressurized food product is made at a first location, shipped, sold and/or is consumed/used at a second location. Typically, the first location is a manufacturing facility, such as in a first state and the sale location and/or point of consumption/use is at a retail facility or residence, such as in a second state.

Some formulations do not ship well and/or are best shipped without certain elements in the formulation, such as a component legal in one location and illegal in a second location. For instance, THC placed into an original food product is not currently legally shipped across state lines. Hence, as described herein, an original food product is optionally sequentially: produced for sale in a first state, shipped across a state line into a state where THC in the food product is legal, amended with THC, and subsequently distributed for sale as an amended product.

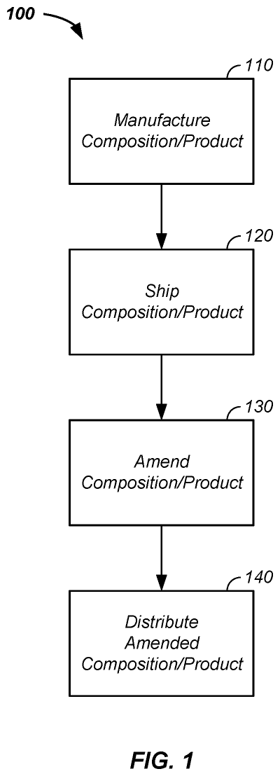

Referring now to FIG. 1, a multiple location product manufacturing system 100 is illustrated. Notably, the multiple location product manufacturing system 100 does not refer to a complete product being manufactured at a first location and the same complete project being manufactured at a second location. Rather, the multiple location product manufacturing system 100 refers to a sequence of processes described herein. In a first process, manufacture of a composition and/or a product 110 is performed at a first location to form an original product, such as a product for sale to an end consumer. Subsequently, in a second process, the composition and/or the original product is shipped 120, such as across a state line, from a first legal jurisdiction to a second legal jurisdiction, to a regulated facility, and/or to a THC certified facility. After shipment, a third process of amending 130 the composition and/or amending the original product is performed, such as addition of THC to the original product. The amendment process 130 optionally includes additional steps, such as the opening of a pressure seal and/or inserting at least one composition element into a pressurized environment of the manufactured and shipped composition and/or the manufactured and shipped product. In a fourth process, the amended composition and/or the amended product, is shipped and/or distributed 140, such as for sale.

### Example I

Still referring to FIG. 1, in a first example of the multiple location product manufacturing system 100, a process of amending the composition/product with at least one added constituent is further described. For clarity of presentation and without loss of generality, the added component in examples herein is THC. Optionally, the added component includes one or more of: THC, a hallucinogen, a psychedelic, a dissociate, a deliriant, and/or a designer drug, where the designer drug contains a structural and/or functional analog of a controlled substance that has been designed to mimic the pharmacological effects of the original drug while at the same time avoiding being classified as illegal. Optionally, the added component includes a chemical, a class of chemicals, a molecule, a class of molecules, a compound, and/or a composition illegal in a first geographic zone, such as at a first manufacturing facility, and legal in a second geographic zone, such as at a product amendment facility. Optionally, the added component includes a mushroom and/or a new tropic, such as a vitamin, limonella, an extract of Eustis Limequat, an extract of a fruit, a portion of a peel of a fruit, a zest, a terpene, and/or niacin. In a first case, the manufactured and shipped product, such as the original product, is in a pressurized environment, such as in an aerosol canister or is packaged in a product side of a piston barrier in a container of a piston barrier system. In this first case, at the second location, the pressure barrier is optionally opened, such as to a higher pressure environment containing THC, THC is added to the aerosol canister which flows into the container as a result of the higher pressure in the THC additive environment, and the container is then resealed in preparation for distribution and/or sale. In a second case, the original product is shipped ready for sale in a first package. The package is opened, the contents are amended, and the amended contents are distributed for sale, such as in the original packaging or in new packaging.

Multiple Location Product Preparation

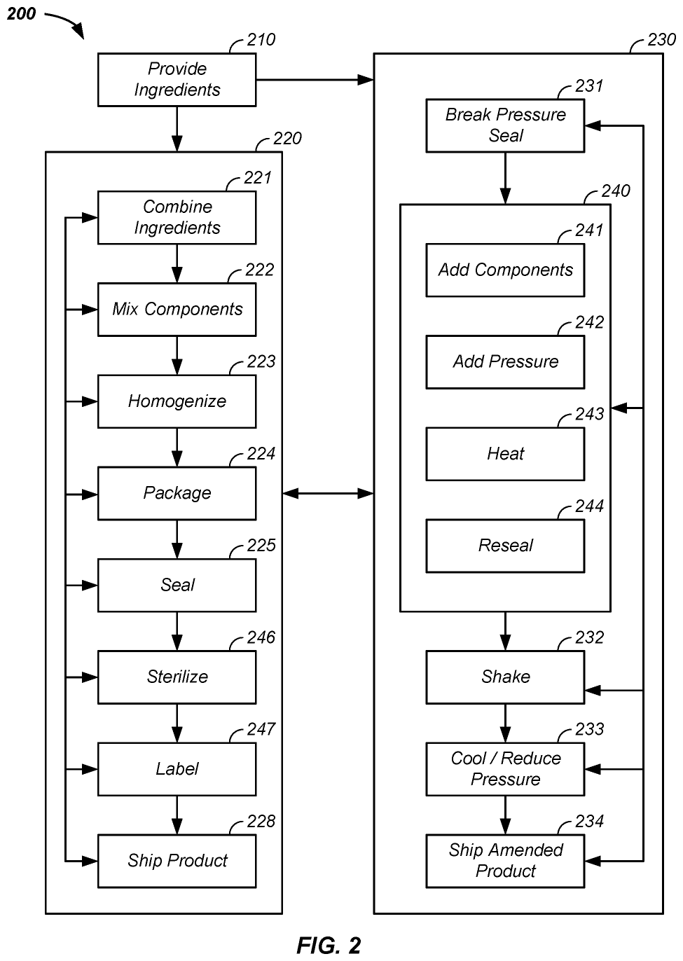

Referring now to FIG. 2, a multiple location product preparation system 200 is described. Optionally and preferably, the multiple location product preparation system 200 is implemented as a portion of the multiple location product manufacturing system 100; however, any and/or all of the steps of the multiple location product preparation system 200 are optionally performed within a single location, such as a THC licensed manufacturing location. Generally, the multiple location product preparation system 200 includes a first location 220 and a second location 230, where zero, one, or more steps of manufacturing a product are performed in each of the first location 220 and/or the second location 230. For example, a described heating step, pressurizing step, shaking step, time passing step, or resealing step, and/or sterilization step are optionally performed more than once, such as at the first location and subsequently at the second location. In another example, a step described herein for clarity of presentation and without loss of generality at the first location 220 is optionally performed only in the second location 230 without performing the step in the first location 220. The multiple location product preparation system 200 is further described in the non-limiting examples herein.

### Example I

Still referring to FIG. 2, a first example of the multiple location product preparation system 200 is provided. In this example, a product formulation includes at least a set of constituents along with optional steps to assemble the ingredients to form the product.

In this first example, in a first step, a first portion of the ingredients is provided 210 to the first location 220, such as a first manufacturing location. Optionally and preferably, a second portion of the ingredients is provided to the second location 230, such as a second manufacturing location. In this example, the provided first ingredients 210 are combined 221, mixed 222, homogenized 223, packaged, 224, sealed 225, sterilized 226, labeled 247, and/or shipped 228. Optionally and preferably, a first set of sub-components of the provided ingredients are combined using one or more of the steps described herein into a first sub-mixture and a second set of sub-components of the provided ingredients are combined using one or more of the steps described herein into a second sub-mixture, where the number of sub-mixtures is any integer n, where n is a positive integer of greater than 1, 2, 3, 4, 5, or more. For instance, the first set of sub-components are combined and formed into an emulsion, such as with a homogenizer, which results in the first mixture. Subsequently, the second mixture is combined with the emulsified first mixture. The emulsification first process aids in forming a uniform distribution of each component in the resulting product and/or aids in dissolving an oil into an aqueous mix or vice-versa.

Still referring to FIG. 2, in one optional and preferred embodiment, the product formed at the first location is ready for distribution and sale. Said again, without any additional step at the second manufacturing location, the product is ready for sale, such as in a retail store to an end customer, an end user, and/or an end consumer. For instance, whipped cream, a spreadable/sprayable cheese, a cookie dough, and/or an icing is prepared and is ready for sale from the first location, such as at a retail facility to a person who will consume the originally manufactured product. Optionally, the original product is amended at the second location, such as by the addition of THC at a THC licensed manufacturing facility. In another embodiment, an incomplete product is formed at the first location that is not fully ready for sale. In this case, the incomplete product is amended and/or finalized at the second location, such as at a THC licensed manufacturing facility.

In this first example, still referring to FIG. 2, in a second step the product and/or the incomplete product formed at the first manufacturing location is subsequently shipped 228 to a second location 230. For clarity of presentation and without loss of generality, several cases of shipping from the first location 220 to the second location 230 are provided in Table 1. For instance, the product and/or the incomplete product is optionally manufactured at a first location in a state, such as Arizona, where addition of THC to a food product is illegal, then the product is shipped to a THC licensed manufacturing facility in Arizona where manufacturing of the incomplete product is finalized and/or the product is amended, such as through addition of one of more constituents, such as an optional THC component. Similarly, the product and/or the incomplete product is optionally manufactured in Utah where addition of THC to a food product is illegal, then the product is shipped to a THC licensed manufacturing facility in Arizona where manufacturing of the incomplete product is finalized and/or the product is amended, such as through addition of one of more constituents that optionally includes THC.

TABLE 1
Shipping

| First Location | Second Location |
|---|---|
| in state at non-THC licensed | in same state at THC licensed |
| manufacturing facility | manufacturing facility |
| first state non-THC licensed | second state THC licensed |
| manufacturing facility | manufacturing facility |
| first government zone/region/area | second government zone/region/area |
| prohibiting THC containing product | allowing THC containing product |
| production | production |

In this first example, still referring to FIG. 2, in a third step the incomplete product and/or product manufactured at the first location 220 is optionally completed and/or amended at the second location 230. For instance, in a sub-case where the incomplete product and/or the product manufactured at the first facility is contained in a pressurized package, such as at greater than one atmosphere, an optional and preferred step is breaking the pressure seal 231. Subsequently or for a non-finalized product or product that is not contained in a pressurized packed, the product is amended in an amendment step 240. Herein, for clarity of presentation, the non-finalized product and the product shipped from the first location 220 are both referred to as products when subsequently operated on, finalized, and/or amended at the second location 230. In the amendment step 240, optionally and preferably components are added 241. For example, THC is amended into the product, such as further described infra. Optionally, the product is also pressurized, repressurized, and/or pressurized to a higher pressure 242; heated 243; and/or resealed 244. Notably, any other manufacturing step described herein or commonly performed is optionally additionally performed as part of the amendment step 240, such as mixing 222, homogenizing 223, sterilizing 224, and/or re-sealing 224. Notably, after and/or as part of the amendment step 240, one or more additional steps optionally occur, such as shaking the current product 232, heating the product, such as to alter a viscosity of one or more constituents of the product, cooling the product, reducing pressure in the container 233, and/or heating the product, such as in a water bath sterilization step. In one case, an ultrasonic mixer is used to mix in the amended constituents, such as THC, into the original product to form the amended product. Similarly, in a second case, an ultrasonic blender, which is distinct from an ultrasonic mixer, is used to homogenize a product amended with a supplemental component, such as THC, to form the amended product. The ultrasonic resonator uses ultrasonic waves that resonate in phase with a natural frequency of a mixable object. For instance, a tube of cheese will have a resonant frequency and the ultrasonic blender applies that resonant frequency to the tube of cheese to mix the tube of cheese. Further, the aforementioned steps of labeling 247 optionally occurs at any time at the second location 230. After the process of adding components 241 to the product, the product is optionally referred to as an amended product, a final product, or simply the product. The amended product is then optionally and preferably distributed/shipped 234 to a retail facility for sale, such as a marijuana dispensary.

### Example II

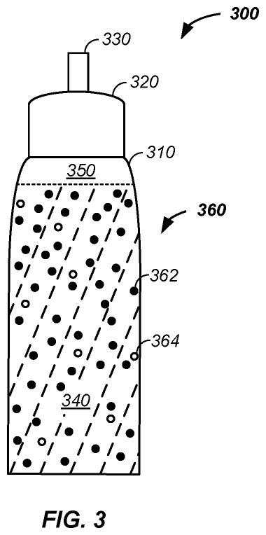

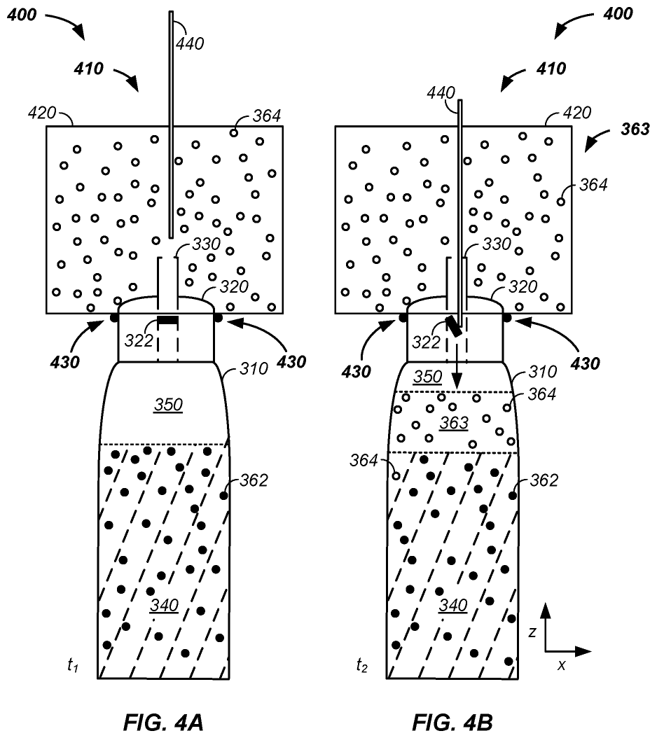

Referring now to FIG. 3, FIG. 4A, and FIG. 4B, a second example is described where a pressurized product is amended.

In the second example, referring now to FIG. 3, a product 300, such as a final product and/or an amended product, is illustrated. As illustrated, the product 300 is packed in a pressurized container 310, such as a canister. The pressurized container 320 include a valve portion 320, which in this case is illustrated in an upper portion of the pressurized container 310. The valve portion 320 contains a lever, valve, and/or port that is repetitively opened and closed by a user, such as to dispense the product 300. As illustrated, the pressurized container 310 contains a delivery port 330.

For clarity of presentation and without loss of generality, in the second example, still referring to FIG. 3, whipped cream is used to describe the product 300, which is dispensed from a pressurized container 310. However, other products are optionally delivered from a pressurized container 310, such as cookie dough, icing, a beverage, or spray cheese. While the pressurized container details will vary with product, such as going from an aerosol container to a canister with a piston wiper valve and a separated pressurized portion of the container, the concepts described herein of opening the pressure seal, amending the product, and resealing/re-pressurizing the container still apply.

In this second example, still referring to FIG. 3, the pressurized container is described in terms of zones and in terms of product constituents. First, the pressurized container 310, as illustrated, contains a liquid/semi-solid zone 340, such as liquid portion or high viscosity portion, and/or a gas zone 350, such as a gas portion 350. For instance, in the case of a whipped cream canister, the liquid portion is cream and the gas portion is a propellant, such as carbon dioxide, argon, a noble gas, butane, and/or preferably nitrous oxide. For clarity of presentation and without loss of generality, the gas is referred to herein as nitrous oxide. The propellant, such as nitrous oxide, resides in the gas portion 350, which is also referred to as a headspace. In the case of nitrous oxide, which is similar to other gases, the nitrous oxide partially dissolves into the cream. When the cream, containing the nitrous oxide, moves from the pressurized contain 310 to atmospheric pressure, the nitrous oxide expands. The expansion of the nitrous oxide expands/whips the cream into whipped cream. Second, the pressurize container 320, as illustrated, contains the product 360, which contains n constituents, where n is a positive integer of greater than 0, 1, 2, 3, 4, 5, or 10. As illustrated in this whipped cream example, a first constituent 362 comprises cream and a second constituent 364, such as THC. For clarity of presentation, the gases dissolved in the cream are not illustrated and components solvating, bonded to, adhered to, chemically bonded to, and/or mixed with the THC are not illustrated. As the cream is dispensed from the pressurized container, through the valve portion 320, and optionally through the delivery port 330, the THC is delivered in the resultant whipped cream.

In this second example, now referring to FIGS. 3, 4A, and 4B, the formation of the amended product in the container, such as the pressurized container 310 is described. The pressurized container 310 contains a valve portion 320.

Generally, the valve portion 320 alternatingly allows passage of a contained component through the valve and stops passage of the contained component through the valve. Many types of valves exist, such as toggle, check, globe, plug, gate, globe, plug, ball, butterfly, check, diaphragm, pinch, pressure relief, Lindal, and/or control valves. Herein, all valve types are openable and closable.

The valve is optionally positioned anywhere in the pressurized container 310 and/or is affixed to the pressurized container 310. As illustrated, the valve portion 320 includes a flow control component 322, which is a portion of any of the above listed valve types.

In this second example, referring still to FIGS. 4A and 4B, an amendment process 400 includes attaching an amendment container 410 to at least to a portion of the pressurized container 310 that is openable, such as the valve portion 320 and/or the delivery port 330. More particularly, a seal is formed between an output of the amendment container 410 and an input/output of the pressurized container 310. Typically, the valve portion 320 of the pressurized container 310 controls dispensing the product 300 out from the pressurized container 310, such as through the delivery port 330. However, in the amendment process, flow through the valve portion 320 is reversed. More particularly, amendment contents 363 of the amendment container 410, such as the second portion of the ingredients, described supra, sequentially passes from the amendment container 410, through the valve portion 320, and into the pressurized container 310. In this manner, contents of the amendment container 410 are transferred into the pressurized container 310, which mix and/or react with the incomplete product and/or the product contained in the pressurized container 310 to form an amended product, current product, updated product, modified product, the final product, a secondary product, and/or, after the addition of contents from the amendment container, simply the product 300.

In this second example, still referring to FIGS. 4A and 4B, the amendment process 400 temporarily opens a passage into the pressurized container, such as through the flow control component 322. As described, supra, many valve types are optionally used. Further, many valve types include sub-options on how to open the valve. For instance, a toggle valve stem is pushed sideways to open up a toggle valve seal, where herein the toggle valve is an example of the valve portion 320 and the toggle valve seal is an example of the flow control unit 322. Further, the stem is a component of the valve. Similarly, a ball valve is another example of the valve portion 320 operated by a lever and the ball with a hole in it that is turned in a ball valve is another example of the flow control unit 322. More generally, any valve type is an example of the valve portion 320 and any operable element of the valve type that controls flow, in and/or out, is an example of the flow control unit 322. As illustrated, an opening/shutting control element 440 operates on the valve portion 320 to alternatingly open and close the valve, which controls flow of substance into and/or out of the pressurized canister 310. Notably, the opening/shutting control element 440 is in a first case built into the valve, such as a handle is built into a ball valve and a stem is built into a toggle valve. However, the opening/shutting control element 440 is in a second case designed for use to open a valve flow control unit 322 in a manner not originally designed into the valve type, as originally manufactured/sold. As illustrated, the opening/shutting control element 440 is inserted into the valve portion 320, optionally through the delivery port 330, where the opening/shutting control element 440 temporarily opens the flow control unit 322. When the opening/shutting control element 440 is withdrawn from contact with the flow control unit 322, the flow control unit 322 shuts and operation of the valve portion as manufactured is restored. The opening/shutting control element 440 is optional when the built in mechanism of the valve portion 320 includes a mechanical and/or an electromechanical element that is built in to control opening and shutting the flow control unit. In this case, the valve portion 320 is optionally opened and/or closed using the originally manufactured control, such as a button, switch, stem control in the toggle valve example, and/or lever in the ball valve example. In this case, the opening/shutting control element 440 is optionally used to operate the original control, such as through a robotic control. For instance, the opening/shutting control element is used to provide a sideways torque to the stem of the toggle valve or to rotate the handle in ball valve examples. Timing of operation of the opening/shutting control element 440 is timed to injection/insertion of the amendment contents 363 from the amendment container 420 into the pressurized canister 310, such as through a direct connection, an injection line or tubing. Generally, an attachment is made between the amendment container 420 and the pressurized container 310 through which the amendment contents 363 flow and the opening/shutting control element 440, timed with a desired flow of the amendment contents 363 into the pressurized container 310, opens and shuts the flow control unit 322 of the valve portion 320. For instance, a hose, through which the amendment contents 363 flow, connects the amendment container 420 to the pressurized container 310 and in the case of a toggle valve, the opening/shutting control element provides a sideways pressure on the stem of the toggle valve to control when the amendment contents 363 flow into the pressurized canister 310.

In the second example, still referring to FIGS. 4A and 4B, as illustrated at the first time, the unamended product, such as the product shipped 228 from the first location 220 contains the liquid zone/high viscosity zone 340 and the gas zone 350. For the illustrative example of whipped cream, the liquid zone 340 comprises cream and the gas zone 350 comprises a propellant, such as nitrous oxide as described supra. Similarly, for a sprayable cheese product, the liquid zone/high viscosity zone 340 comprises liquid cheese and/or semi-liquid cheese and there is essentially no gas zone in a food product chamber. At the first time, t₁, the amendment container 420 is attached to the pressurized container 310.

For instance a tube connects an output of the amendment container 420 to an as yet still closed input element of the pressurized container. Optionally, the connection is air tight for the case of an already pressurized container. The connection could simply be gravity directing flow of output from the amendment container 420 to the pressurized container 310 in cases where the pressurized container is not yet pressurized and/or has not yet been sealed, such as in a process of fitting the valve portion 320 onto and/or into the pressurized container 310. In another case, beverage components, such as in a bright bath, are amended with THC and/or a THC emulsion, where the amended bright bath is canned or bottled In this case, the original product is a premixed syrup concentrate and the amended product introduces THC into the syrup/beverage mix, where the THC amended mix is subsequently canned or bottled. At a second time, t₂, at least a portion of the amendment contents 363 are transferred from the amendment container 420 into the pressurized container 310. As illustrated, during at least a portion of the second time, t₂, the opening/shutting control element 440 functions to open the flow control unit 322, as described supra. The delivery of the amendment contents 363 to the pressurized container is driven by a force, such as: gravity, a pump, a timed pump, and/or a pressure differential. Optionally, delivery of the amendment contents 363 additionally adds pressure and/or delivers a first pressure to the contents of the pressurized container 310. For instance, the delivery of the amendment contents 363 from a pressurized version of the amendment container 420 is used to bring the pressure inside the pressurized container 310 to a final shipping pressure of less than 200 psi, such as in a range of 140 to 180 psi.

Still referring to FIG. 4B, timing and flow of the amendment contents 363 is optionally and preferentially controlled and/or monitored with a flow valve. As illustrated, at the second time, t₂, the amendment contents 363 initially form, for a time period of less than 10 microseconds to a time period of greater than four hours, a zone that is not yet equilibrated or mixed into the liquid/semi-solid zone/high viscosity zone 340 and/or the gas zone 350. However, the amendment contents 363 mix with the liquid/high viscosity zone 340 and/or the gas zone 350 as further described, infra.

Herein, the second constituent 364, such as THC, in the amendment contents 363 is optionally and/or preferably in a natural form, in a purified form, in a liquid form, in a suspension, in a colloidal suspension, in a micelle, in a liposomal solution, dissolved in a solvent such as greater than 1, 2, 5, 10, 25, or 50 percent ethanol and/or greater than 1, 2, 5, 10, 25, or 50 percent butane, and/or is pre-homogenized to aid in mixing with the contents of the liquid/high viscosity zone 340 of the pressurized container 310. For instance, the inventors have discovered that THC dissolved in ethanol diffuses/permeates into liquid cheese to uniformly distribute the THC in the cheese product. Optionally and preferably, THC and/or THC in a solvent, such as ethanol, is a component of a formed suspension/emulsion, such as THC in water or THC in an aqueous mix, such as a beverage component. Optionally and preferably, the THC is emulsified in the water/aqueous mix along with one or more of: a surfactant, such as lecithin, an ester of glycerol, a Tween, such as Tween 20, 40, 60, or 80; a polysaccharide, such as gum Arabic, sap of an acacia tree, pectin, inulin, and/or Jujube polysaccharide; and/or a protein, such as soy protein, whey protein, pea protein isolate, and/or a gelatin.

Timing and/or volume of flow of the amendment contents 363, which either produce directly or are used to calculate a volume of flow are additionally combined with a concentration to calculate/yield an amount of delivered product, such as milligrams of THC added to a container, such as the pressurized canister. The amount of THC is optionally digitally added to a certification report, which is optionally part of a certified and regulatory controlled chain of reports tracking THC along any portion from production, through isolation/extraction, to addition to a formulation, to distribution, and/or sale.

In the second example, referring now to FIG. 4B and FIG. 3, the amendment contents 363 are mixed into the liquid/semi-solid zone/high viscosity zone 340 and/or the gas zone 350 of the final product. As illustrated in FIG. 4B, after even a short time period, such as less than 1, 30, or 60 seconds, a portion of the amendment contents 363, such as THC dissolve and/or move into the liquid/semi-solid zone/high viscosity zone 340. Transfer of the amendment contents 363, such as THC, from an amendment zone into the liquid/semi-solid zone/high viscosity zone 340 of the final product is facilitated in a number of ways, such as any of shaking, heating, and/or stirring. For instance, after addition of the amendment contents 363 into the pressurized canister 310 and optionally and preferably after removing all connections between the amendment container 420 and the opening/shutting control element 440 and the pressurized canister 310, the pressurized canister 310 is shaken 232 and/or heated to a temperature in excess of 25° C., such as above 30, 35, 40, 45, 50, 55, or 60° C. for a period of time, such as in excess of 1, 2, 3, 4, 5, 10, or 20 minutes. For instance, for the case of a pressurized cheese product, the heating decreases the viscosity of the cheese to form at least a layer of liquid cheese product, which facilitates natural liquid-to-liquid movement of a liquid form of the amendment contents 363 into the liquid/high viscosity zone 340, which results in a more homogenized or evenly distributed content of the amendment contents 363, such as the THC, in the liquid/high viscosity zone 340. Optionally and preferably the heating step heats to a temperature above that of a typical liquid bath sterilization step of the resultant packaged product. As the optional temperature mixing step optionally and preferably exceeds temperature and time requirements of a typical liquid bath sterilization step, the heating step optionally replaces the sterilization step.

Still referring to FIGS. 3, 4A, and 4B, the pressurized canister 310 is optionally any type of pressurized container, such as an aerosol container where the pressure is distributed with the canister in contact, interspersed into, and/or dissolved within the food product; a valve type container, where the pressurized gas is behind a valve and force the valve to move toward a dispensing valve forcing the food product out of the container when the valve is opened; and/or is a bag-in-can type canister.

Referring now to Table 3, two sequential methods are provided, the sequential methods corresponding to sequential action of the second to fourth column of Table 2, for amending and/or finalizing a food product in a pressurized container.

TABLE 2
Finalizing/Amending Product

| | | Subsequent | Additional |
|---|---|---|---|
| | Manufacturing | Manufacturing | Manufacturing |
| Case | Step | Step | Step |
| First Case | Open Pressure | Add Product | Pressurize and |
| | Seal | Constituent | Seal Product |
| Second | Open Pressure | Add Product | Seal Product |
| Case | Seal | Constituent while | |
| | | Increasing Pressure | |

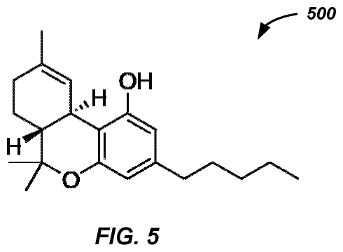

Referring now to FIG. 5, tetrahydrocannabinol 500 is illustrated.

Tetrahydrocannabinol (THC) is one of at least 113 cannabinoids identified in cannabis. Herein, the tetrahydrocannabinol and/or THC optionally refers to isomers of cannabinoid, tetrahydrocannabinol isomers, and/or (−)-trans-Δ⁹-tetrahydrocannabinol. Tetrahydrocannabinol is the principal psychoactive constituent of cannabis.

Optionally THC is reacted with a reagent, R, to form a THC derivative, such as a THC-R molecule, where the THC-R molecule retains and/or enhances psychoactive properties of THC, where the reagent, R, chemically aides dissolution, homogenization, solubility, and/or emulsification of the THC portion of the THC-R molecule in a body of the product, an aqueous based product, and/or a product containing greater than 10, 20, 30, 40, 50, 60, 70, 80, or 90 percent water and/or a hydrophilic substance, and/or where the reagent, R, chemically and/or physically decreases viscosity of a THC containing additive, which aids in homogenization, distribution, and/or mixing of the THC into a viscous product, such as a cheese product and/or a cookie dough. For example, chemical reagent R and molecular sub-component R optionally and preferably has a hydrophilic end and an attachment end, where the attachment end bonds with THC and the hydrophilic end aid is dissolution in water or forming a suspension in water.

Still yet another embodiment includes any combination and/or permutation of any of the elements described herein.

Herein, a set of fixed numbers, such as 1, 2, 3, 4, 5, 10, or 20 optionally means at least any number in the set of fixed number and/or less than any number in the set of fixed numbers.

Herein, any number optionally includes a range of numbers such as the number, n, ±1, 2, 3, 4, 5, 10, 20, 25, 50, or 100% of that number.

The particular implementations shown and described are illustrative of the invention and its best mode and are not intended to otherwise limit the scope of the present invention in any way. Indeed, for the sake of brevity, conventional manufacturing, connection, preparation, and other functional aspects of the system may not be described in detail. Furthermore, the connecting lines shown in the various figures are intended to represent exemplary functional relationships and/or physical couplings between the various elements. Many alternative or additional functional relationships or physical connections may be present in a practical system.

In the foregoing description, the invention has been described with reference to specific exemplary embodiments; however, it will be appreciated that various modifications and changes may be made without departing from the scope of the present invention as set forth herein. The description and figures are to be regarded in an illustrative manner, rather than a restrictive one and all such modifications are intended to be included within the scope of the present invention. Accordingly, the scope of the invention should be determined by the generic embodiments described herein and their legal equivalents rather than by merely the specific examples described above. For example, the steps recited in any method or process embodiment may be executed in any order and are not limited to the explicit order presented in the specific examples. Additionally, the components and/or elements recited in any apparatus embodiment may be assembled or otherwise operationally configured in a variety of permutations to produce substantially the same result as the present invention and are accordingly not limited to the specific configuration recited in the specific examples.

Benefits, other advantages and solutions to problems have been described above with regard to particular embodiments; however, any benefit, advantage, solution to problems or any element that may cause any particular benefit, advantage or solution to occur or to become more pronounced are not to be construed as critical, required or essential features or components.

As used herein, the terms “comprises”, “comprising”, or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present invention, in addition to those not specifically recited, may be varied or otherwise particularly adapted to specific environments, manufacturing specifications, design parameters or other operating requirements without departing from the general principles of the same.

Although the invention has been described herein with reference to certain preferred embodiments, one skilled in the art will readily appreciate that other applications may be substituted for those set forth herein without departing from the spirit and scope of the present invention. Accordingly, the invention should only be limited by the Claims included below.

1. A method for amending an original product, comprising the steps of:
receiving the original product in a first pressurized container;
breaking a pressure seal of said first pressurized container;
adding tetrahydrocannabinol (THC) to said first pressurized container; and
resealing said first pressurized container.

2. The method of claim 1, said step of breaking further comprising the step of:
opening a valve component connected to said first pressurized container.

3. The method of claim 2, said step of adding further comprising the steps of:
attaching a delivery tube from a THC containing container to said valve component; and
passing, sequentially, the THC from said THC containing container, through said tube, and into said first pressurized container.

4. The method of claim 1, said step of adding further comprising the step of:
increasing pressure in said first pressurized container by at least five percent.

5. The method of claim 1, said step of adding THC further comprising the step of:
attaching a pressurized canister to said first pressurized container.

6. The method of claim 1, said step of adding further comprising the step of:
delivering the THC from a second container into said first pressurized container, said second container comprising an initial pressure at least five percent greater than an original pressure in said first pressurized container.

7. The method of claim 1, further comprising the step of:
shipping the first pressurized container from a first geographic zone where packaging THC at doses greater than five milligrams per serving illegal to a second geographical zone where packaging THC in excess of five milligrams per serving is legal.

8. The method of claim 1, said step of adding further comprising the step of:
delivering said tetrahydrocannabinol through a valve of said first pressurized container.

9. The method of claim 1, said step of adding further comprising the step of:
forcing, with a pressure differential, the tetrahydrocannabinol from a second pressurized container, through a valve of said first pressurized container, and into said first pressurized container.

10. The method of claim 1, further comprising the steps of:
obtaining the original product in ready for sale packaging; and
after said step of adding, distributing for retail sale said THC amended product in said ready for sale packaging.

11. The method of claim 10, further comprising the step of:
amending said ready for sale packaging with an adult use only warning label.

12. The method of claim 1, further comprising the step of:
measuring flow of said THC into said first pressurized container with a digital flow meter.

13. The method of claim 1, further comprising the step of:
forming an emulsion, said emulsion comprising THC, water, and at least one of:
a surfactant;
lecithin; and
gum Arabic.

14. The method of claim 1, further comprising the step of:
forming an emulsion, said emulsion comprising THC, water, and at least one of:
a polysaccharide based emulsifier;
a polysaccharide emulsifying agent;
a protein based emulsifier; and
a protein emulsifying agent.

15. The method of claim 1, further comprising the step of:
emulsifying THC with an ultrasonic homogenizer.

16. The method of claim 1, further comprising the step of:
emulsifying THC with an ultrasonic homogenizer to form a first emulsion; and
further emulsifying said first emulsion with a high pressure homogenizer, said high pressure homogenizer forcing, with pressure, said first emulsion through a homogenizer valve of less than one inch diameter.

17. The method of claim 1, further comprising the steps of:
said step of breaking said pressure seal further comprising the step of providing a lateral force to a stem of a toggle valve of said first pressurized container; and
said step of adding THC to said first pressurized container further comprising the step of delivering the THC into said first pressurized container through at least a portion of said toggle valve.

18. The method of claim 1, further comprising the steps of:
said step of breaking said pressure seal further comprising the step of deforming, with air pressure, a rubber seal of a toggle valve of said first pressurized container; and
said step of adding THC to said first pressurized container further comprising the step of delivering the THC into said first pressurized container through at least a portion of said toggle valve.
